(19) United States
(12) Patent Application Publication
(10) Pub. No.: US 2026/0352651 A1
(43) Pub. Date: Nov. 5, 2026

(54) SERVER SYSTEM AND UNAUTHORIZED USER DETECTION METHOD

(71) Applicant: Hitachi Vantara, Ltd., Kanagawa-ken (JP)

(72) Inventor: Yoshiyuki TABATA, Tokyo (JP)

(21) Appl. No.: 19/105,225

(22) PCT Filed: Aug. 25, 2023
(86) PCT No.: PCT/JP2023/030661

§ 371 Date: Feb. 20, 2025

(30) Foreign Application Priority Data
Feb. 21, 2023 (JP) 2023-025451

(51) Int. Cl. H04L 9/40

(52) U.S. Cl. CPC H04L 63/0823; H04L 63/10

(57) ABSTRACT

To implement detection of an unauthorized user and improve security of a server system, the server system includes: a client 120 for receives an access from a user; and an authorization server 130 as a server for accepting grant from the client 120 and processing a request of authentication and/or authorization of the user. The server receives the request, acquires an identifier that represents the user, and stores the identifier in a response to the request. The client 120 receives the response from the user, acquires an identifier that represents the user, and compares the acquired identifier with the identifier stored, thereby determines whether a transmission source of the response is a valid user.

### TECHNICAL FIELD

The present invention relates to a server system and an unauthorized user detection method.

### BACKGROUND ART

Conventionally, as technologies of authentication and authorization, authorization code flows of OAuth 2.0 (RFC 6749) and OpenID Connect Core 1.0 and SP-initiated SAML have been known.

Furthermore, as a technology for selecting an appropriate authorization server when there are a plurality of authorization servers, a technology disclosed in Japanese Patent Application Publication No. 2020-53100 (PTL 1) has been known. PTL 1 indicates that “An authorization server includes: first transmission means for specifying, upon reception of an authorization request, a first authorization server at which user information is located and transmitting an authentication request to the first authorization server, the first authorization server being configured to authenticate a user; second transmission means for transmitting an authorization response to a client together with information indicating that the first authorization server at which the user information is located as a transmission destination, the client being configured to specify, on the basis of the authorization response, the first authorization server by second specifying means; third transmission means for transmitting a token request for requesting an authorization token for accessing a resource server to the first authorization server; and issuing means for issuing, by the first authorization server, an authorization token in response to the token request”.

### CITATION LIST

### Patent Literature

[PTL 1] Japanese Patent Application Publication No. 2020-53100

### SUMMARY OF INVENTION

### Technical Problem

The conventional technologies cannot prevent a situation in which an unauthorized user logs in to a client as a valid user. Taking OAuth as an example, there has been a problem in that a user (unauthorized user) different from a user who has been authenticated by an authorization server and acquired authorization (consent) can log in to a client. As described above, the conventional technologies have insufficient security for unauthorized accesses.

It is therefore an object of the present invention to implement detection of an unauthorized user to improve security of a server system.

### Solution to Problem

In order to achieve the above-mentioned object, according to representative one aspect of the present invention, there is provided a server system, including: a client for receiving an access from a user; and a server for accepting grant from the client and processing a request of authentication and/or authorization of the user, in which: the server receives the request, acquires an identifier that represents the user, and stores the identifier in a response to the request; and the client receives the response from the user, acquires an identifier that represents the user, and compares the acquired identifier with the identifier stored in the response to determine whether a transmission source of the response is a valid user.

Furthermore, according to representative one aspect of the present invention, there is provided an unauthorized user detection method for a server system, the server system including: a client for receiving an access from a user; and a server for accepting grant from the client and processing a request of authentication and/or authorization of the user, the unauthorized user detection method including the steps of: receiving, by the server, the request, acquiring an identifier that represents the user, and storing the identifier in a response to the request; and receiving, by the client, the response from the user, acquiring an identifier that represents the user, and comparing the acquired identifier with the identifier stored in the response to determine whether a transmission source of the response is a valid user.

### Advantageous Effects of Invention

According to the present invention, detection of an unauthorized user can be implemented to improve security of a server system. Problems, configurations, and effects other than those described above become apparent by the following description of embodiments.

### BRIEF DESCRIPTION OF DRAWINGS

FIG. 1 is an explanatory diagram of basic processing of authentication and authorization.

FIG. 2 is an explanatory diagram of processing of authentication and authorization by a system in Embodiment 1.

FIG. 3 is an explanatory diagram of blocking of unauthorized accesses.

FIG. 4 is an explanatory diagram of system elements.

FIG. 5 is a configuration diagram of the entire system.

FIG. 6 is a flowchart illustrating a processing procedure of an authorization server.

FIG. 7 is a flowchart illustrating a processing procedure of a

FIG. 8 is an explanatory diagram of data managed by the system.

FIG. 9 is an explanatory diagram of usage of the data.

FIG. 10 is an explanatory diagram of management of the data.

### DESCRIPTION OF EMBODIMENTS

Embodiments are described below with reference to the drawings.

### Embodiment 1

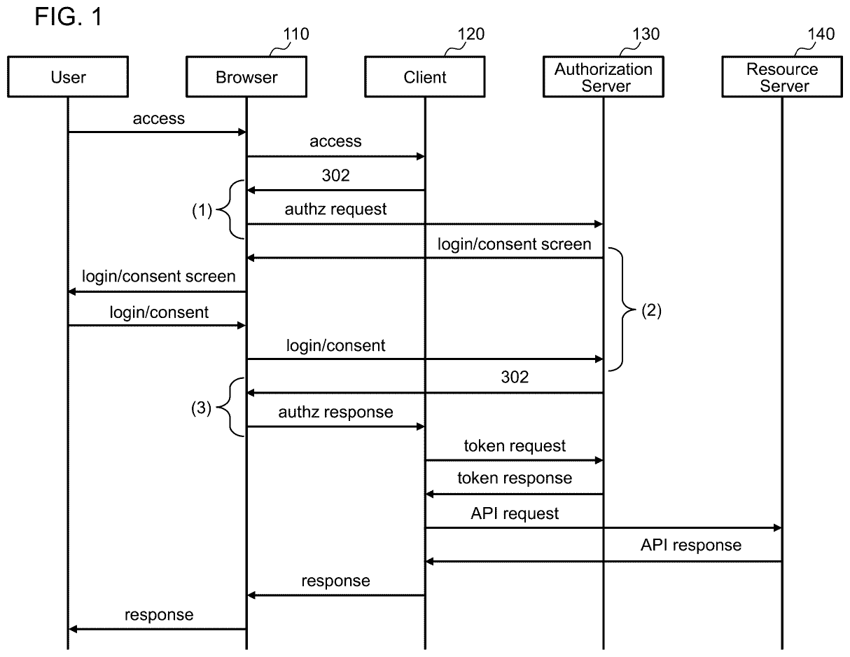

FIG. 1 is an explanatory diagram of basic processing of authentication and authorization. FIG. 1 is a specific example of an authorization code flow of OAuth 2.0 or OIDC Core 1.0.

A user accesses a client 120 through a browser 110 of a user terminal. In this case, the client 120 requests the provision of data stored in a resource server 140.

The client 120 grants authentication and authorization of the user to an authorization server 130 (1). Specifically, the client 120 controls the browser 110 to redirect with the authorization server 130 as a destination. As a result, the browser 110 transmits an authorization request to the authorization server 130.

The authorization server 130 that has received the authorization request executes authentication and authorization processing (2). Specifically, the authorization server 130 transmits a screen (login screen) for receiving input of login information and a screen (consent screen) for receiving confirmation input to the browser 110. The browser 110 displays the login screen and the consent screen, and receives input by the user. The browser 110 transmits received data to the authorization server 130. The authorization server 130 uses the data received from the browser 110 to perform authentication and authorization of the user.

The authorization server 130 returns a result of the authentication and the authorization to the client 120 as an authorization response (3). Specifically, the authorization server 130 controls the browser 110 to redirect with the client 120 as a destination. As a result, the browser 110 transmits an authorization response to the client 120.

The client 120 transmits a token request to the authorization server 130, and receives a token response from the authorization server 130. After that, the client 120 transmits an API (Application Programming Interface) request to the resource server 140. The resource server 140 provides data to the client 120 by an API response.

In the basic processing illustrated in FIG. 1, it cannot be confirmed that a user that has logged in by the authentication and authorization processing (2) and a user that has returned the result by the result return processing (3) are identical. Thus, in the system in the present embodiment, identifiers that represent a user are acquired, and it is determined whether a user in the authentication and authorization processing (2) and a user in the result return processing (3) are identical.

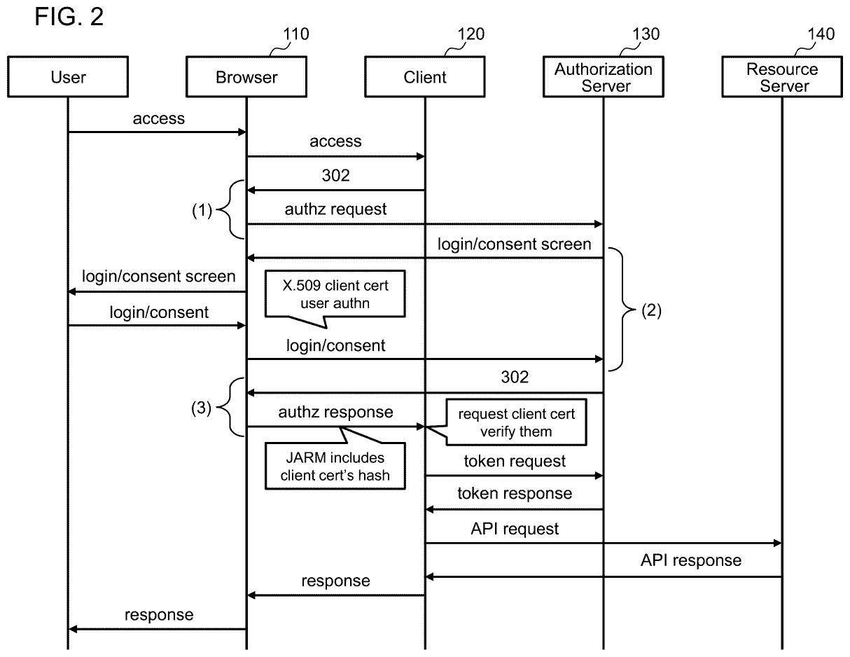

FIG. 2 is an explanatory diagram of authentication and authorization processing by the system in Embodiment 1. In the authentication and authorization processing (2) in FIG. 2, a browser 110 transmits a client certificate to an authorization server 130 together with data input by a user on a login screen and a consent screen. The authorization server 130 stores a hash value of the client certificate in an authorization response.

In result return processing (3) in FIG. 2, a client 120 receives the authorization response, and acquires the hash value of the client certificate from the browser 110. The client 120 compares the client certificate acquired from the browser 110 with the hash value of the client certificate included in the authorization response. As a result of the comparison, when the client certificates are identical, the client 120 determines that the access has been made from a valid user, and provides data in the resource server 140.

As described above, in the system in Embodiment 1, data on a client certificate is acquired in the authentication and authorization processing (2) and the result return processing (3), and the pieces of data are compared. The client certificate is an example of an identifier that represents a user. As the identifier that represents a user, data that can be used as a user credential and that cannot be acquired by a phishing attack, such as a client certificate, is used. For example, in the case of a client certificate, even if a user encounters a phishing attack and is guided to a fake website prepared by an attacker, the attacker cannot steal a secret key of a client. Thus, the attacker cannot present a client certificate to the client and the authorization server by impersonating a valid user. The identifier that represents a user may be an identification number of an IC card.

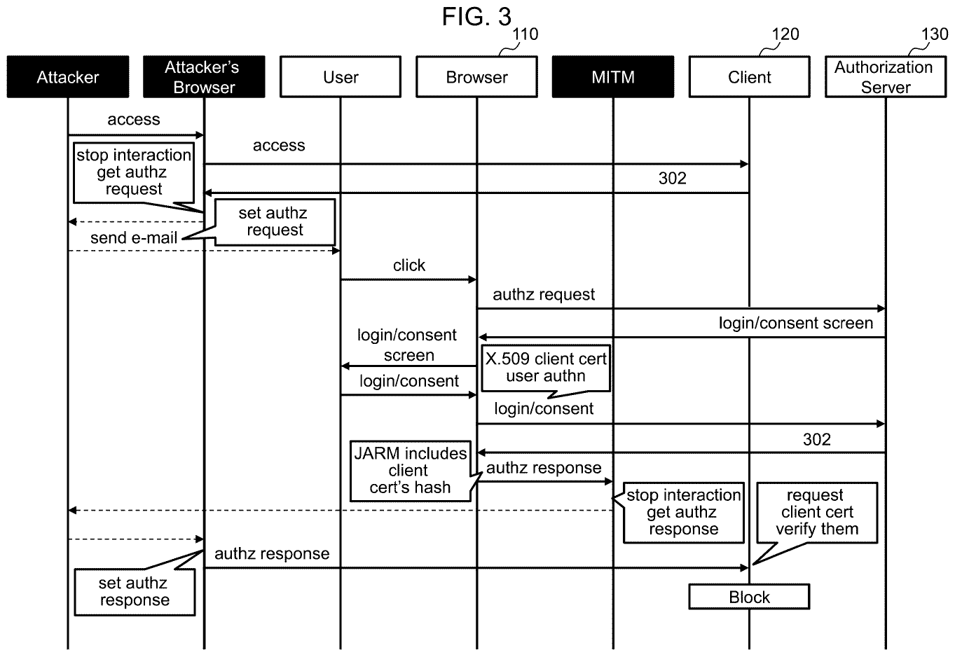

FIG. 3 is an explanatory diagram of blocking of unauthorized accesses. An attacker, who is an unauthorized user, accesses a client 120 through a browser of a user terminal of the attacker. The client 120 grants authentication and authorization of a user to an authorization server 130. Specifically, the client 120 controls the browser of the attacker to redirect with the authorization server 130 as a destination. The attacker stops processing at this time, and acquires an authorization request. Then, the attacker sends an e-mail having the authorization request set as a hyperlink to a valid user. When the valid user opens the e-mail and clicks the hyperlink, a browser 110 transmits the authorization request to the authorization server 130.

The authorization server 130 that has received the authorization request executes authentication and authorization processing. Specifically, the authorization server 130 transmits a screen (login screen) for receiving input of login information and a screen (consent screen) for receiving confirmation input to the browser 110. The browser 110 displays the login screen and the consent screen, and receives input by the valid user. The browser 110 transmits the received data to the authorization server 130. The authorization server 130 uses the data received from the browser 110 to authenticate and authorize the user. In other words, the authentication and authorization are performed by the valid user.

The authorization server 130 returns a result of the authentication and authorization to the client 120 as an authorization response. Specifically, the authorization server 130 redirects to the browser 110 with the client 120 as a destination. As a result, the browser 110 transmits the authorization response to the client 120. In this case, the attacker, who is an unauthorized user, intervenes as a man in the middle, stops the processing, and illegally acquires an authorization response.

The attacker tries an unauthorized access by transmitting the illegally acquired authorization response to the client 120.

In the basic processing illustrated in FIG. 1, the client 120 cannot detect that users have been switched, and the access by the attacker succeeds.

However, in FIG. 3, the authorization server 130 stores a hash value of a client certificate acquired from the browser 110 in the authorization response as data. Then, the client 120 acquires a client certificate by the TCP layer when the browser transmits the authorization response, and compares the hash value of the client certificate included in the authorization response as data with the client certificate transmitted by the TCP layer upon the transmission of the authorization response. If an attacker has transmitted an authorization response, a client certificate cannot be acquired, or client certificates mismatch. Thus, the client 120 determines that the access has been made from an unauthorized user, and can block the access.

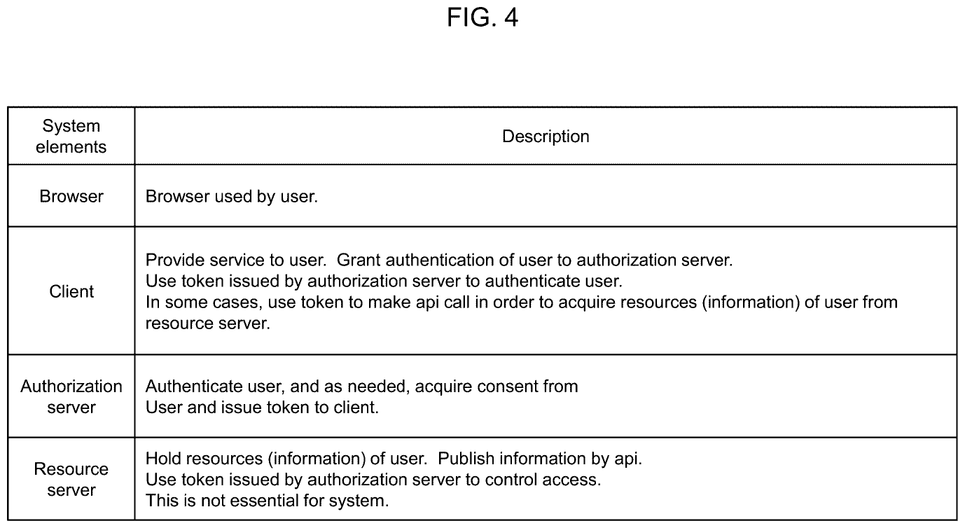

FIG. 4 is an explanatory diagram of system elements. FIG. 4 illustrates an explanatory diagram taking OAuth 2.0 and OIDC Core 1.0 as an example.

Browser is a browser used by a user. The user accesses a client and an authorization server through the browser.

Client provides service to a user. The client grants authentication of the user to the authorization server. Furthermore, the client uses a token issued by the authorization server to authenticate the user. In some cases, the client uses a token to make an API call in order to acquire resources (information) of a user from a resource server.

Authorization server authenticates a user, and as needed, acquires consent from the user, and issues a token to the client.

Resource server holds resources (information) of a user. The resource server publishes the information by API. Furthermore, the resource server controls an access by using an token issued by the authorization server. Note that the resource server is not essential for this system.

Furthermore, in the system in the present embodiment, the authorization server has a function of acquiring an identifier that represents a user and storing the identifier in an authorization response. Furthermore, the client has a function of acquiring an identifier that represents a user and comparing the acquired identifier with the identifier stored in the authorization response to determine whether the user is a valid user.

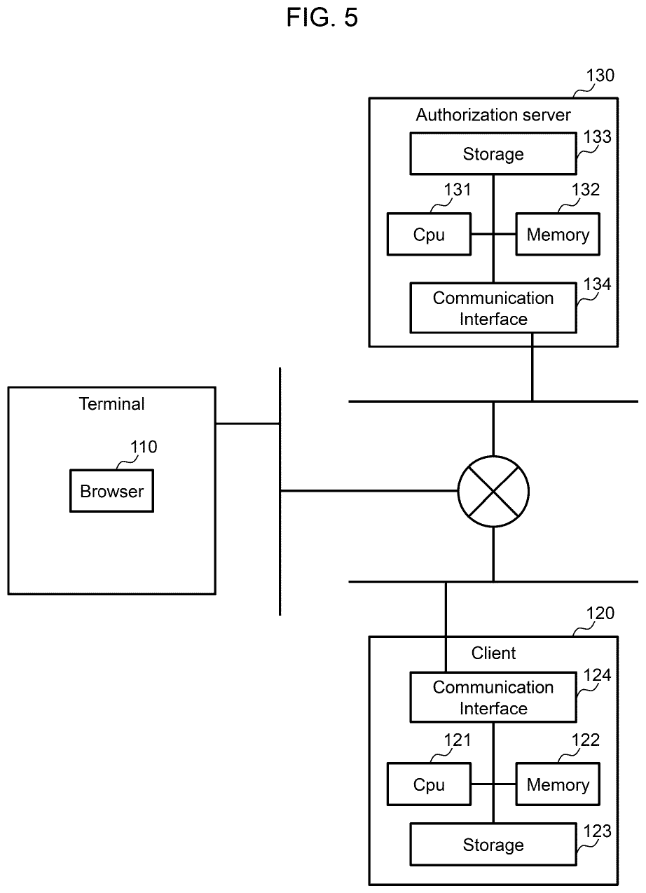

FIG. 5 is a configuration diagram of the entire system.

The browser 110 operates on a terminal of a user.

The client 120 is a computer including a CPU (Central Processing Unit) 121, a memory 122, storage 123, and a communication interface 124. Specifically, the CPU 121 reads predetermined programs from the storage 123, develops the programs onto the memory 122, and sequentially executes the programs, thereby implementing various functions as the client 120. Furthermore, the communication interface 124 performs communications with the browser 110 and the authorization server 130.

The authorization server 130 is a computer including a CPU 131, a memory 132, storage 133, and a communication interface 134. Specifically, the CPU 131 reads predetermined programs from the storage 133, develops the programs onto the memory 132, and sequentially executes the programs, thereby implementing various functions as the authorization server 130. Furthermore, the communication interface 134 performs communications with the browser 110 and the client 120.

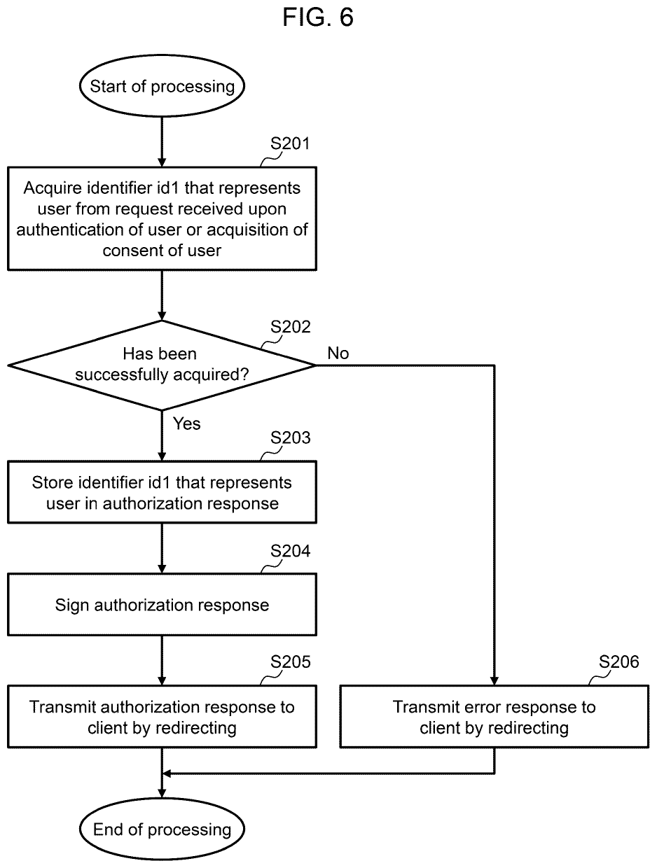

FIG. 6 is a flowchart illustrating a processing procedure of the authorization server. The authorization server 130 sequentially executes the following processing of Steps S201 to S206.

Step S201: The authorization server 130 acquires an identifier ID1 that represents the user from a request received upon the authentication of the user or the acquisition of consent of the user. After that, the processing proceeds to Step S202.

Step S202: The authorization server 130 determines whether the identifier ID1 that represents the user has been successfully acquired. When the authorization server 130 has successfully acquired the identifier ID1, the processing proceeds to Step S203. When the authorization server 130 has failed to acquire the identifier ID1, the processing proceeds to Step S206.

Step S203: The authorization server 130 stores an identifier ID1 that represents a user in an authorization response. After that, the processing proceeds to Step S204.

Step S204: The authorization server 130 signs the authorization response. After that, the processing proceeds to Step S205.

Step S205: The authorization server 130 transmits the authorization response to the client 120 by redirecting, and finishes the processing.

Step S206: The authorization server 130 transmits an error response to the client 120 by redirecting, and finishes the processing.

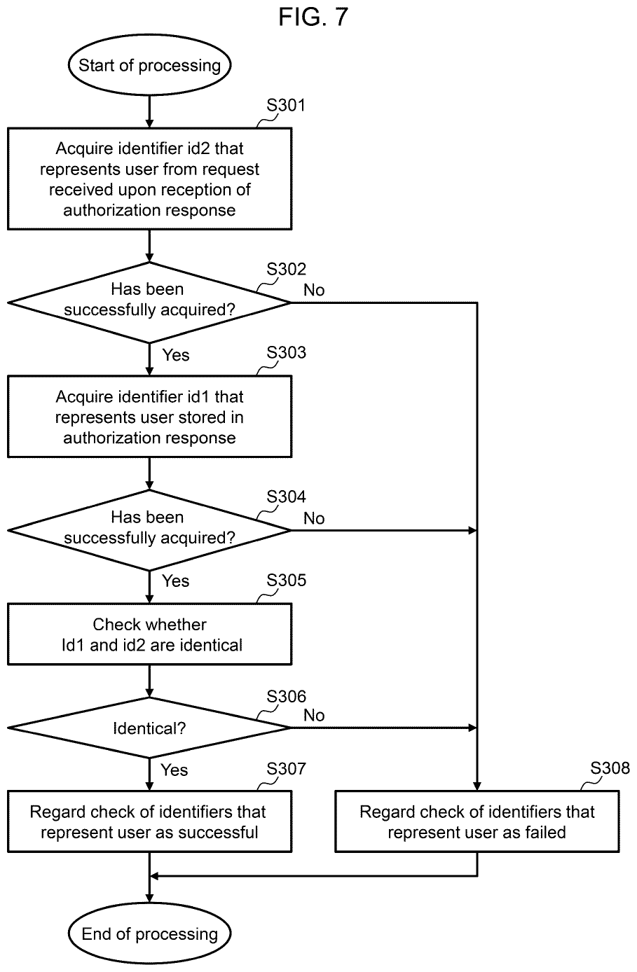

FIG. 7 is a flowchart illustrating a processing procedure in the client 120. The client 120 sequentially executes the following processing of Steps S301 to S308.

Step S301: The client 120 acquires an identifier ID2 that represents a user from a request received upon reception of the authorization response. After that, the processing proceeds to Step S302.

Step S302: The client 120 determines whether the identifier ID2 that represents the user has been successfully acquired. When the client 120 has successfully acquired the identifier ID2, the processing proceeds to Step S303. When the client 120 has failed to acquire the identifier ID2, the processing proceeds to Step S308.

Step S303: The client 120 acquires an identifier ID1 that represents the user stored in an authorization response.

Step S304: The client 120 determines whether the identifier ID1 that represents the user has been successfully acquired. When the client 120 has successfully acquired the identifier ID1, the processing proceeds to Step S305. When the client 120 has failed to acquire the identifier ID1, the processing proceeds to Step S308.

Step S305: The client 120 performs processing of comparing the identifier ID1 and the identifier ID2 and checking whether the identifier ID1 and the identifier ID2 are identical. After that, the processing proceeds to Step S306.

Step S306: The client 120 determines whether the identifier ID1 and the identifier ID2 are identical. When the identifier ID1 and the identifier ID2 are identical, the processing proceeds to Step S307. When the client 120 has failed to acquire, the processing proceeds to Step S308.

Step S307: The client 120 regards the checking of the identifiers that represent the user as successful, and finishes the processing. In other words, the client 120 determines that the transmission source of the authorization response is a valid user, and finishes the processing.

Step S308: The client 120 regards the checking of the identifiers that represent the user as failed, and finishes the processing. In other words, the client 120 determines that the transmission source of the authorization response is an unauthorized user, and finishes the processing.

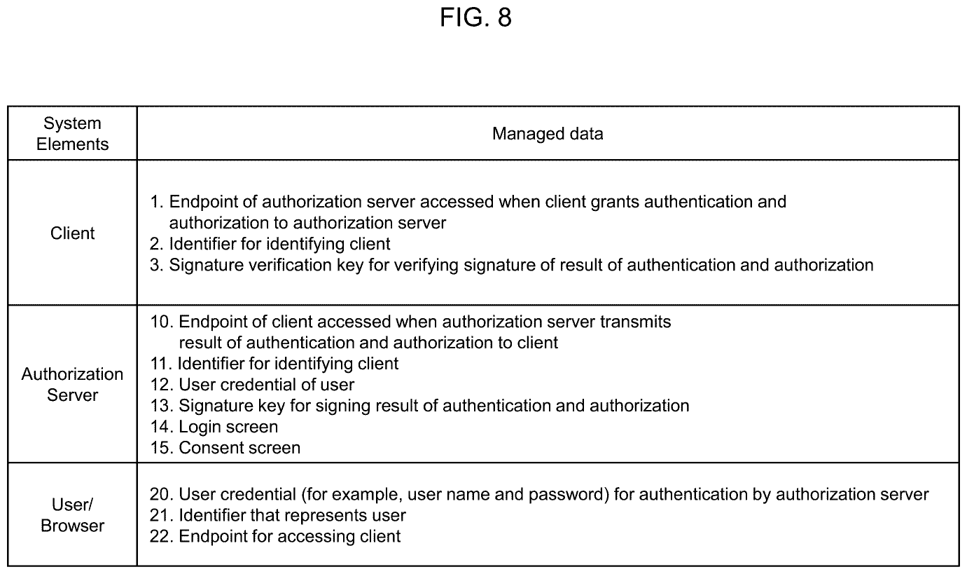

FIG. 8 is an explanatory diagram of data managed by the system.

The client 120 manages the following data.
1. Endpoint of the authorization server when the client grants authentication and authorization to the authorization server
2. Identifier for identifying the client
3. Signature verification key for verifying a signature of a result of authentication and authorization

The authorization server 130 manages the following data.
10. Endpoint of a client to be accessed when the authorization server transmits a result of authentication and authorization to the client
11. Identifier for identifying the client
12. User credential of the user
13. Signature key for signing a result of authentication and authorization
14. Login screen
15. Consent screen

The user or the browser 110 manages the following data.
20. User credential (for example, user name and password) for authentication by the authorization server
21. Identifier that represents a user
22. Endpoint for accessing a client

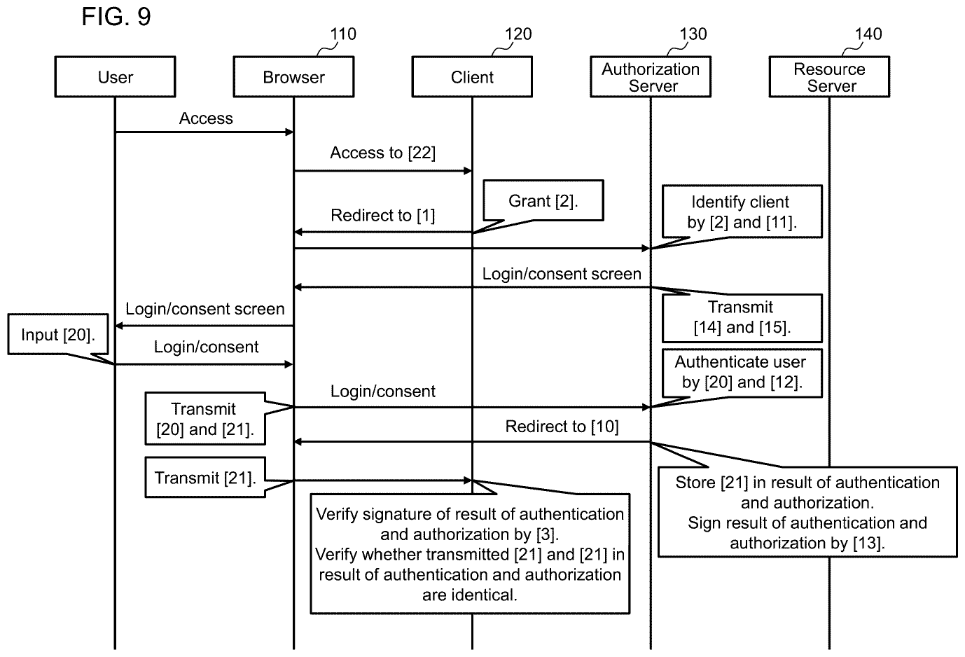

FIG. 9 is an explanatory diagram of usage of the data illustrated in FIG. 8.

The browser 110 accesses the client 120 with the endpoint 22 as a destination.

The client 120 gives the identifier 2, and redirects to the authorization server 130 with the endpoint 1 as a destination.

The authorization server 130 identifies a client by the identifier 2 and the identifier 11, and transmits the login screen 14 and the consent screen 15 to the browser 110.

The user inputs the user credential 20, and the browser 110 transmits the user credential 20 and the identifier 21 to the authorization server 130.

The authorization server 130 authenticates the user by the user credential 20 and the user credential 12. Then, the authorization server 130 stores the identifier 21 in a result of authentication and authorization (authorization response), signs the result of authentication and authorization by the signature key 13, and redirects to the endpoint 10 (client 120).

The browser 110 transmits the identifier 21 when redirecting the result of authentication and authorization to the client 120.

The client 120 verifies the signature of the result of authentication and authorization by the signature verification key 3. Then, the client 120 verifies whether the transmitted identifier 21 and the identifier 21 in the result of authentication and authorization are identical.

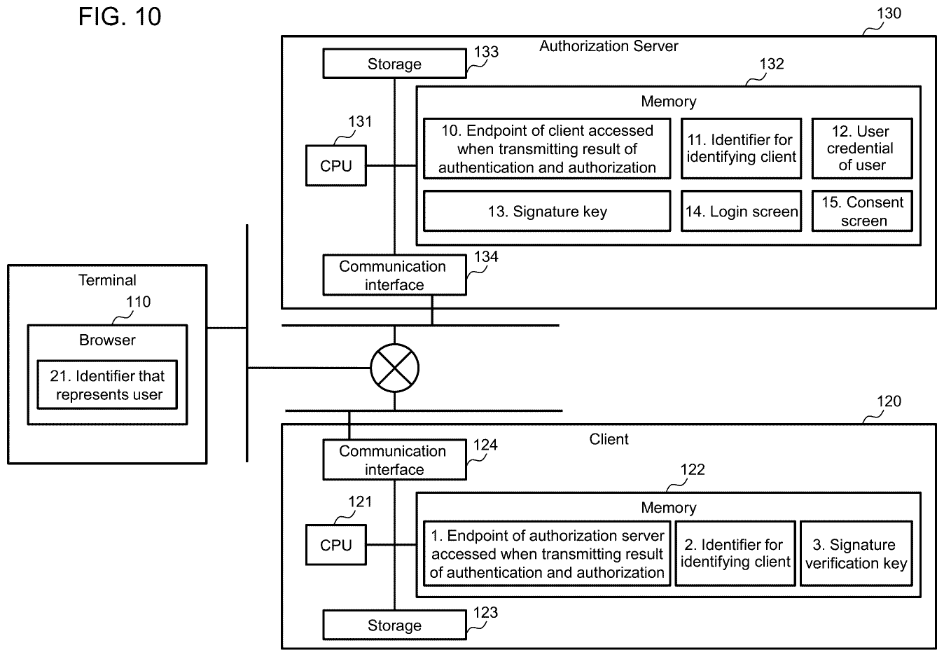

FIG. 10 is an explanatory diagram of management of data.

The identifier 21 that represents a user is managed by the browser 110.

The endpoint 1 of a client accessed when transmitting a result of authentication and authorization, the identifier 2 for identifying the client, and the signature verification key 3 are stored in the memory 122 of the client 120.

The endpoint 10 of a client accessed when transmitting a result of authentication and authorization, the identifier 11 for identifying the client, the user credential 12, the signature key 13, the login screen 14, and the consent screen 15 are stored in the memory 132 of the authorization server 130.

As described above, the disclosed server system includes: the client 120 for receiving an access from a user; and the authorization server 130 as a server for accepting grant from the client 120 and processing a request of authentication and/or authorization of the user, in which: the server receives the request, acquires an identifier that represents the user, and stores the identifier in a response to the request; and the client 120 receives the response from the user, acquires an identifier that represents the user, and compares the acquired identifier with the identifier stored in the response to determine whether a transmission source of the response is a browser of a valid user.

Thus, an unauthorized user can be detected to improve security of the server system.

Furthermore, the server authenticates and authorizes the user, and the client denies an access from a transmission source of the response when a result of the comparison indicates mismatch.

Thus, an access from an unauthorized user performed by exploiting a result of authentication and authorization of a valid user can be blocked.

As the identifier that represents the user, a client certificate can be used.

Furthermore, as the identifier that represents the user, identification information read from a predetermined medium by a terminal of the user can be used.

As the identifier that represents the user, data that can be used as a user credential and that cannot be acquired by a phishing attack, such as a client certificate, is used. For example, in the case of a client certificate, even if a user encounters a phishing attack and is guided to a fake website prepared by an attacker, the attacker cannot steal a secret key of a client. Thus, the attacker cannot present a client certificate to the client and the authorization server by impersonating a valid user.

Furthermore, the server electronically signs the response in which the identifier that represents the user has been stored, and the client performs the comparison after verifying the electronic signature.

Thus, it can be confirmed that the identifier stored in the response has not been rewritten, and security is improved.

Furthermore, the disclosed server system further includes the resource server 140 for holding resource data to be provided to the user, and the server authorizes an access to the resource data.

Thus, an unauthorized access to the resource data can be prevented.

Note that the present invention is not limited to the above-mentioned embodiments and includes various modifications. For example, the embodiments have been described above in detail in order to facilitate the description of the present invention, and are not always limited to the ones that include all the configurations described above. Furthermore, the configurations may be omitted, and may be replaced or added.

For example, the present invention is also applicable to a case where authentication and authorization are granted in multiple steps.

### REFERENCE SIGNS LIST

110 Browser
120 Client
130 Authorization server
140 Resource server

1. A server system, comprising:
a client for receiving an access from a user; and
a server for accepting grant from the client and processing a request of authentication and/or authorization of the user, wherein:
the server receives the request, acquires an identifier that represents the user, and stores the identifier in a response to the request; and
the client receives the response from the user, acquires an identifier that represents the user, and compares the acquired identifier with the identifier stored in the response to determine whether a transmission source of the response is a valid user.

2. The server system according to claim 1, wherein:
the server authenticates and authorizes the user; and
the client denies an access from a transmission source of the response when a result of the comparison indicates that the identifiers mismatch.

3. The server system according to claim 1, wherein the identifier that represents the user comprises a client certificate.

4. The server system according to claim 1, wherein the identifier that represents the user comprises identification information read from a predetermined medium by a terminal of the user.

5. The server system according to claim 1, wherein:
the server electronically signs the response in which the identifier that represents the user has been stored; and
the client performs the comparison after verifying the electronic signature.

6. The server system according to claim 1, further comprising a resource server for holding resource data to be provided to the user,
wherein the server authorizes an access to the resource data.

7. An unauthorized user detection method for a server system, the server system including:
a client for receiving an access from a user; and
a server for accepting grant from the client and processing a request of authentication and/or authorization of the user,
the unauthorized user detection method comprising:
a step of receiving, by the server, the request, acquiring an identifier that represents the user, and storing the identifier in a response to the request; and
a step of receiving, by the client, the response from the user, acquiring an identifier that represents the user, and comparing the acquired identifier with the identifier stored, thereby determining whether a transmission source of the response is a valid user.
